(19) United States
(12) Patent Application Publication
(10) Pub. No.: US 2009/0109023 A1
(43) Pub. Date: Apr. 30, 2009

(54) Apparatus and method for locating a motor vehicle by visible indication

(76) Inventor: Shawn Newman, Derry, NH (US)

Correspondence Address: Russ Weinzimmer, 614 Nashua Street, Suite 53, Milford, NH, 03055, US

(21) Appl. No.: 11/982,175

(22) Filed: Oct. 31, 2007

(51) Int. Cl. G08B 21/00; G08B 5/36; G01C 21/26

(52) U.S. Cl. 340/540; 340/691.1; 701/207; 701/213

(57) ABSTRACT

An apparatus and method of use are disclosed that facilitate locating a motor vehicle by providing a visible indication on the vehicle that enables nearby individuals to realize that the vehicle is being sought. In one aspect, the visible indication is activated by a signal transmitted by the police or another government authority, or by an automated toll booth, automatic radar speed checkpoint, or other automated device. In another aspect, the visible indication device is activated automatically when the apparatus detects that the registration, insurance, etc. has expired, or that the license plate does not match the vehicle. Preferred embodiments include date and/or time tracking, and/or GPS, and transmit response signals to the government authority when activated. In preferred embodiments, the visible indication device is attached to the license plate frame, emits light, and includes a plurality colored lights or other distinguishable indications corresponding to different reasons for activation.

### FIELD OF THE INVENTION

The invention generally relates to devices and methods for locating vehicles, and more specifically to devices and methods for providing a visible indication on a vehicle that is sought by a government authority.

### BACKGROUND OF THE INVENTION

There are many circumstances under which the police or some other government authority wishes, or even urgently desires, to locate a specific motor vehicle. In some cases, the vehicle is the subject of an active search, for example because it is stolen, or is suspected to be transporting missing children, criminal suspects, terrorists, etc. In other cases, the vehicle may have failed to meet a regulatory requirement (e.g. expired license, insurance, registration, etc), or it may have committed a traffic violation, failed to pay a toll, violated a parole or restraining order, or committed some other infraction that does not necessarily warrant an active search, but nevertheless causes the vehicle to be of interest if it could be readily identified and located.

Even when police and other law enforcement agencies have been alerted and are actively looking for a vehicle, it can be difficult for them to find the vehicle, since it is often necessary for the vehicle to have a chance encounter with a law enforcement officer or other representative of a government authority before it can be recognized and apprehended. Typically, there is no easy way for the general public to assist the authorities in locating a specific vehicle, because there is no effective means by which the vehicle can be made recognizable to the general public as being of interest to the authorities.

Indeed, given the large number of vehicles that may be traveling on a roadway at any given time, even police officers and other representatives of government agencies must exercise a high degree of awareness to notice and identify a specific vehicle during a brief, chance encounter on a busy road. Failure to recognize that a vehicle is wanted and may contain dangerous occupants can even be a threat to the safety of a police officer or other official if he or she approaches the vehicle due to a routine traffic stop or for some other seemingly innocent reason without realizing that the vehicle is wanted.

Due to the difficulty and manpower requirements of an active vehicle search, such searches are typically reserved only for urgent and critical situations. Many vehicle infractions are recognized and automatically recorded without triggering a search, such as when a vehicle has failed to satisfy a regulatory requirement, failed to pay a toll, failed to pay a parking ticket, traveled at too high a speed through an automated radar speed checkpoint, etc. In such cases, a photograph and/or a computer generated report may be recorded, but the vehicle is typically not located and the infraction is not addressed until some future time, if at all, even though the vehicle has countless chance encounters with police and other officials. In the vast majority of cases that do not trigger an active search, there is simply no means during a chance encounter for an official of a government authority, let alone a member of the general public, to recognize that a particular vehicle is in violation of a regulatory or legal requirement, or is otherwise being sought.

Efforts are sometimes made to gain the help of the general public by alerting them to look for a specific vehicle. Such so-called “amber alerts” and other public alert programs use media announcements, electronic signs, pictures printed on milk cartons, etc. to inform the public regarding a specific vehicle that is being sought. This approach has proven to be somewhat effective, but at best only a small fraction of the public is reached by such an alert, and an even smaller fraction remembers the alert long enough, and has sufficient awareness, to be of help in locating the vehicle. In addition, this approach is not effective if alerts are issued for more than a few vehicles at a time.

Another approach for locating a vehicle is to attach a transponder to the vehicle, possibly equipped with a global positioning system or “GPS” and to activate it when needed, for example when the vehicle is reported stolen. This approach has had some success. However, it requires two-way communication between a government authority and the vehicle, for example by radio, cell phone, or satellite, and these methods of communication can be easily obstructed by tunnels, mountains, etc, thereby preventing the device from being activated and/or preventing it from reporting its location. In addition, GPS requires communication with satellites, which can be similarly obstructed. Also, this approach does not enable members of the general public to be of assistance in locating the vehicle.

Similar approaches automatically detect a failure of a vehicle to meet a regulatory requirement and report the failure, and in some cases also the vehicle's position, to a government authority by radio or similar means. Such devices can be triggered automatically, for example when a computer recognizes that the vehicle registration has expired, when the vehicle fails to pay a toll at a toll booth, or when it exceeds the speed limit while passing through an automated radar speed checkpoint. However, these approaches also suffer from the problems of possible obstruction of the communication means and failure to enable the general public to be of assistance.

### SUMMARY OF THE INVENTION

An apparatus and method of use are disclosed that provide a visible indication on a motor vehicle when the vehicle is sought by a government authority. The apparatus includes a visible indication device and an activating system that activates the visible indication device when an activating event occurs. Without the need for any special alert to the public, the visible indication device enables members of the general public that happen to be near the vehicle to recognize that the vehicle is being sought and to provide assistance by contacting the police or other government officials. The visible indication device also helps police and other government officials who encounter the vehicle and who may not otherwise have been alerted to realize that the vehicle is being sought, and to take proper precautions if the occupants are considered dangerous.

The visible indication device is attached to, or made part of, the license plate frame, or it is attached to some other easily visible location on the motor vehicle. The apparatus is powered either by the motor vehicle battery or by a rechargeable, dedicated battery that is charged by the vehicle battery. In some preferred embodiments, the apparatus is resistant to unauthorized tampering, and in some preferred embodiments the visible indication device is automatically activated if the motor vehicle battery ceases to maintain the dedicated battery in a charged state.

In preferred embodiments, the visible indication device is a light emitting device, and in some preferred embodiments the color and/or other features of the emitted light and/or other visible indication gives an indication of the reason for activation. In some preferred embodiments the device is activated by a signal transmitted by a government authority, or by an automated device under the control of a government authority. In these embodiments, communication with the apparatus is required only for a brief moment, after which the visible indication device renders the vehicle easy to recognize and locate even if mountains or other obstacles interfere with the reception and/or transmission of signals. In other preferred embodiments the apparatus is automatically activated, without any need for an external signal, when a failure to meet a regulatory requirement is detected. Such failures can include expiration of a certification that must be renewed at defined intervals, such as the vehicle registration, vehicle safety inspection, and/or vehicle insurance. Other failures can include leaving a specified area, for example when the driver is on parole, entering a specified area, for example when there is a restraining order against the driver, and/or driving at certain times, such as a youth driving late at night.

In preferred embodiments, the activating system comprises a date tracking mechanism that is able to determine if the defined interval for meeting a regulatory requirement has passed, as well as a means for allowing a government authorized entity to update the most recent date of compliance with the regulatory requirement. In other preferred embodiments, the activation system comprises a means to detect both the vehicle identification number and the license number of the vehicle license plate, and to verify that the license plate displayed by the vehicle is registered to the vehicle. Still other preferred embodiments comprise means to determine the approximate location of the motor vehicle and the time of the day.

In preferred embodiments, the invention includes means for sending a wireless signal that informs a government authority when the visible indication device has been activated, and in some of these preferred embodiments the wireless signal assists the government authority in determining the location of the motor vehicle. In these preferred embodiments, transmission of signals from the apparatus to a government authority enhances the ease of locating the vehicle when the signals are not blocked by mountains, tunnels, etc. However, once activated, the visible indication device allows the vehicle to be located even when transmission of signals from the apparatus to a government authority is not possible.

### BRIEF DESCRIPTION OF THE DRAWINGS

FIG. 1 is a block diagram illustrating the structure and operation of the apparatus;

FIG. 2A is a perspective view of a vehicle with an activating system installed behind the dashboard and a visible indication device installed on the license plate frame;

FIG. 2B is a perspective view of a vehicle with an activating system installed behind the dashboard and a visible indication device installed on the rear of the vehicle near the license plate frame;

FIG. 3A is a perspective drawing that illustrates a signal transmitted to the activating system of the invention by a government authority, thereby causing the activation system to activate the visible indication device;

FIG. 3B is a perspective drawing that illustrates a signal transmitted by the invention to a government authority indicating that the visible indication device has been activated, and also providing the approximate location of the vehicle;

FIG. 4 is a perspective drawing that illustrates activation of the visible indication device upon passing through a toll booth without paying the toll;

FIG. 5A is a flow diagram that illustrated activation of the apparatus by a wireless signal transmitted by a government authority.

FIG. 5B is a flow diagram that illustrates the automatic activation of the visible indication device upon detection of an expired regulatory requirement by an activating system that includes a date tracking mechanism;

FIG. 6 is a flow diagram that illustrates the automatic activation of the visible indication device upon detection of an incorrect license plate by an activating system that is able to detect and verify the correspondence between the license plate number and the VIN number;

FIG. 7A is a perspective view of a preferred embodiment where the visible indication device is directly powered by the vehicle battery; and

FIG. 7B is a functional illustration of a preferred embodiment wherein the visible indication device is powered by a rechargeable battery that is maintained at charge by the vehicle battery.

### DETAILED DESCRIPTION OF PREFERRED EMBODIMENTS

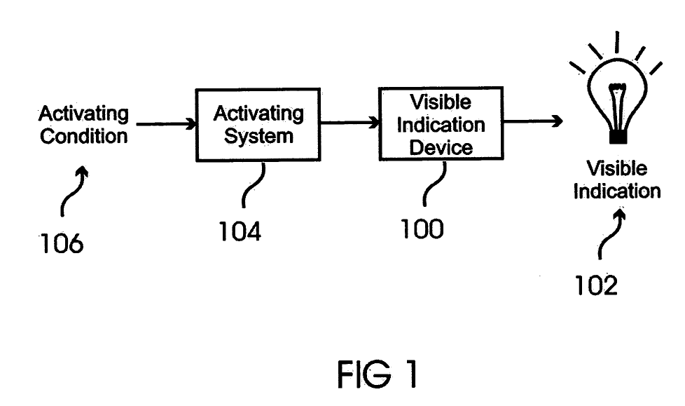

With reference to FIG. 1, the apparatus of the invention includes a visible indication device 100 mounted such that it provides a visible indication 102 that is readily visible to individuals near the vehicle, and an activating system 104 that activates the visible indication device 100 when an activating condition 106 occurs.

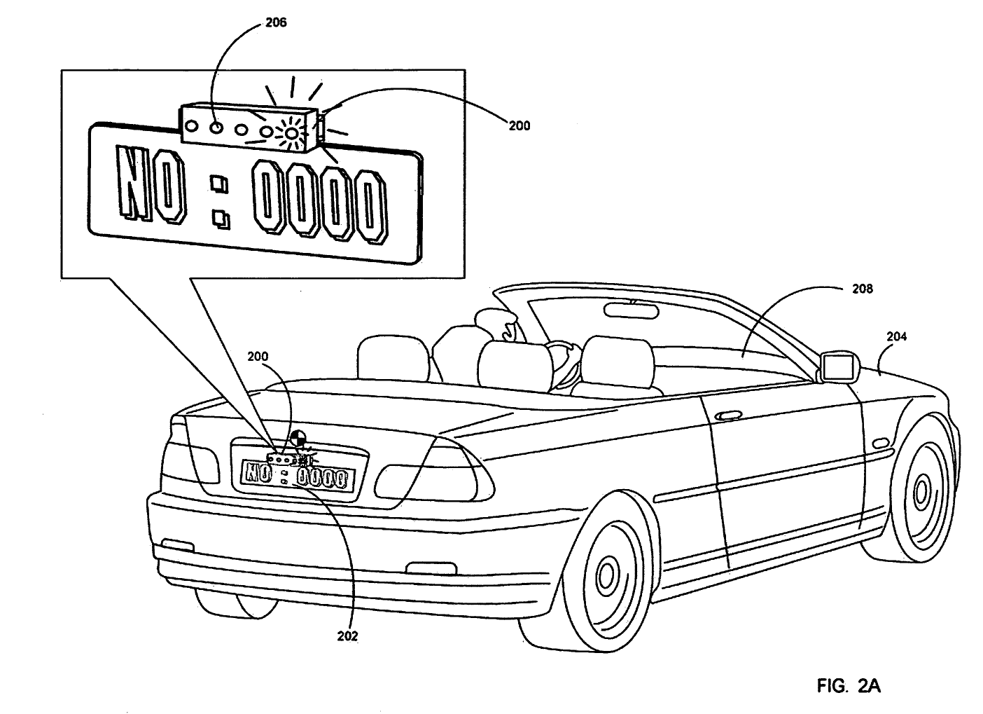

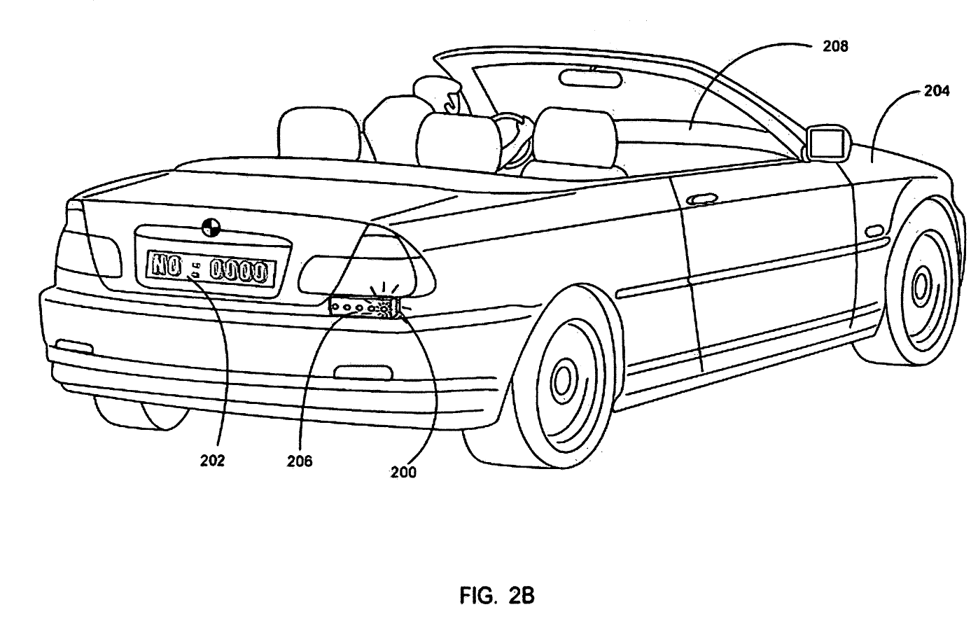

FIG. 2A is a perspective view of a preferred embodiment wherein the visible indication device 200 is mounted above the license plate 202 of a vehicle 204. In this embodiment the visible indication device 200 is able to provide a plurality of different indications 206, each of which corresponds to a different category of infraction, degree of urgency, or reason for seeking the vehicle. In this embodiment, the activating system 208 is mounted behind the dashboard of the vehicle 204 where it cannot be seen or easily accessed by the occupant. In other preferred embodiments, the activating system 208 is mounted in other inaccessible locations, such as under the hood, under the floor, etc, or it is mounted within the housing of the visible indication device 200.

FIG. 2B is a perspective view of a preferred embodiment that is similar to the preferred embodiment of FIG. 2A, except that the visible indication device 200 is mounted to the rear body of the vehicle 204 instead of to the license plate 202. In other preferred embodiments, the visible indication device 200 is mounted to other locations on the vehicle that are visible to surrounding individuals, such as the roof, the rear window, etc.

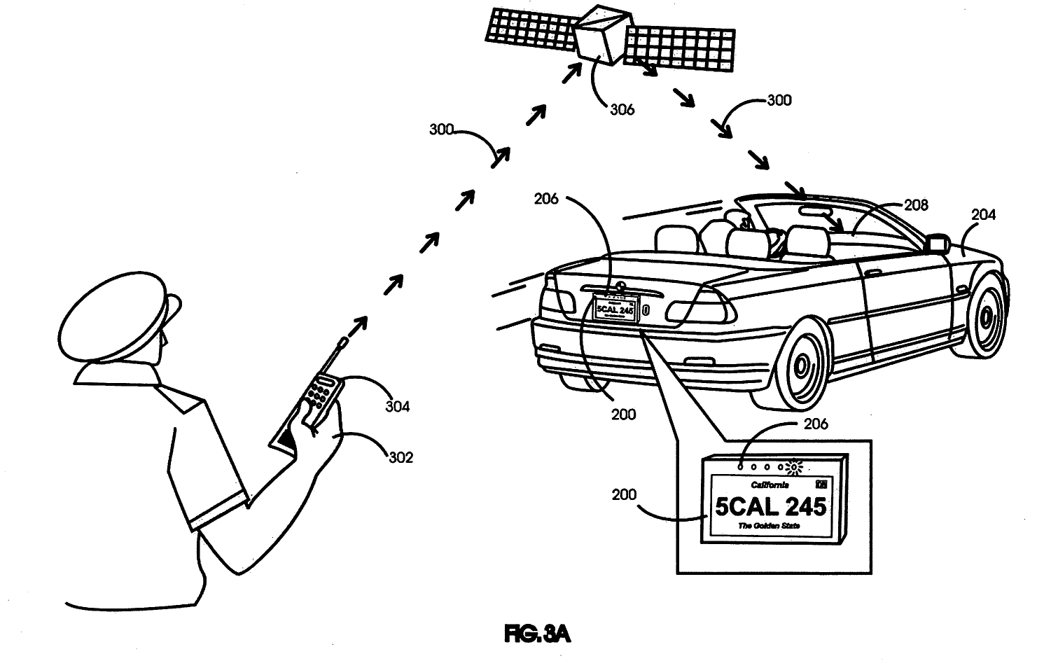

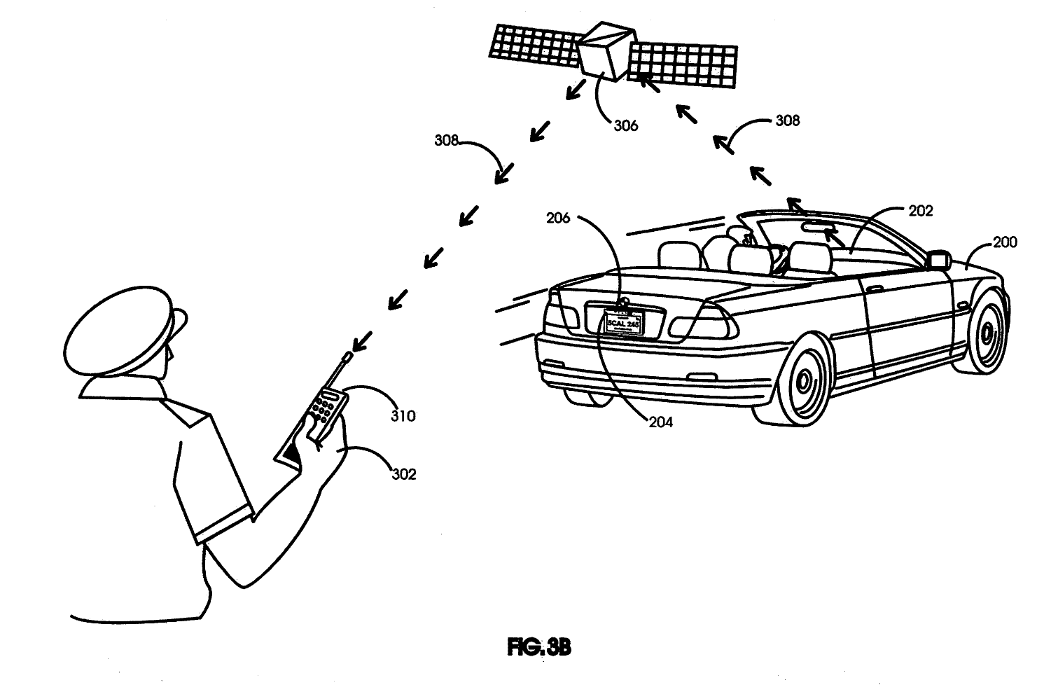

FIG. 3A is a perspective drawing that illustrates a preferred embodiment wherein the activating event is a wireless signal 300 transmitted by the police or another government authority 302 to the activating system 208 hidden behind the dashboard. In other preferred embodiments, the activating system 208 is contained within the special license plate frame together with the visible indication device 200. In the embodiment of FIG. 3A, the signal is transmitted by a device 304 that communications with the activating system 208 through a satellite 306. In other preferred embodiments, the signal is transmitted by a radio or cell phone tower, or by other wireless means. In this embodiment, reception of the wireless signal 300 is only necessary for a brief moment, so as to activate the apparatus. After activation, the visible indication device 200 allows the vehicle 204 to be located even if mountains, tunnels, or other obstacles prevent the reception of further wireless signals.

In the preferred embodiment of FIG. 3A, the visible indication device 200 is contained within a special license plate frame and includes a series of lights 206 that can be illuminated to indicate different reasons why the vehicle is sought. In similar preferred embodiments, part or all of the perimeter of the license plate frame is surrounded by a nearly continuous series of lights, contained for example in a plastic tube, such that activation causes part or all of the rim of the license plate frame to “light up” and draw attention. In some of these embodiments, the color of the illumination indicates the reason for activation

FIG. 3B is a perspective drawing of the preferred embodiment of FIG. 3A that illustrates the transmission of a wireless response 308 from the apparatus back to the police or other government authority 302. As in FIG. 3A, the wireless response 308 is illustrated as utilizing a satellite 306, but in other preferred embodiments the signal is transmitted by a radio or cell phone tower, or by other wireless means. In various preferred embodiments, the response signal indicates that the visible indication device has been activated and/or provides information regarding the current location of the vehicle as determined by a GPS device included in the apparatus, by triangulation of the origin of the signal, or by other location means. In these preferred embodiments, transmission of a wireless response 308 from the apparatus to a government authority 302 enhances the ease of locating the vehicle 204 when the response 308 is not blocked by mountains, tunnels, etc. However, the visible indication device 200 allows the vehicle 204 to be located even when transmission of a response 308 from the apparatus to a government authority 302 is not possible.

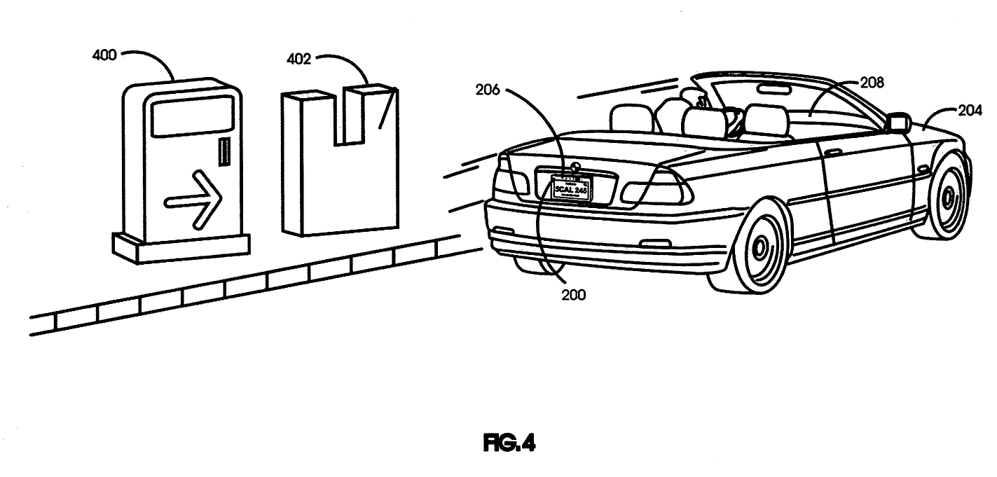

FIG. 4 is a perspective drawing that illustrates a preferred embodiment wherein the visible indication device 200 is activated by a signal that is transmitted automatically by a toll booth 400 to the activating system 208 hidden behind the dashboard when the vehicle 204 passes through the toll gate 402 without paying the required toll.

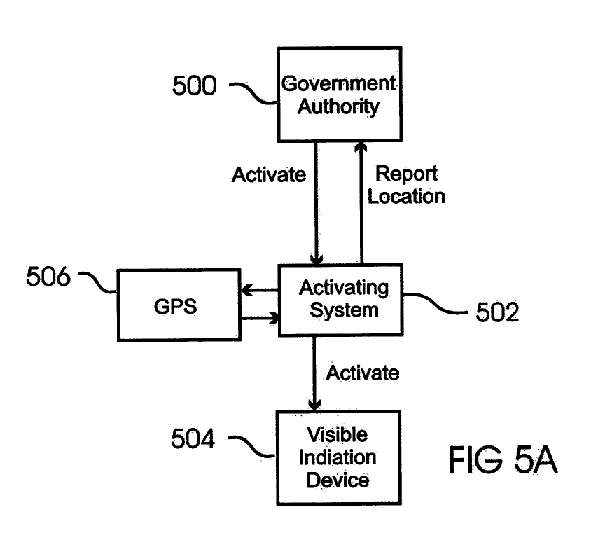

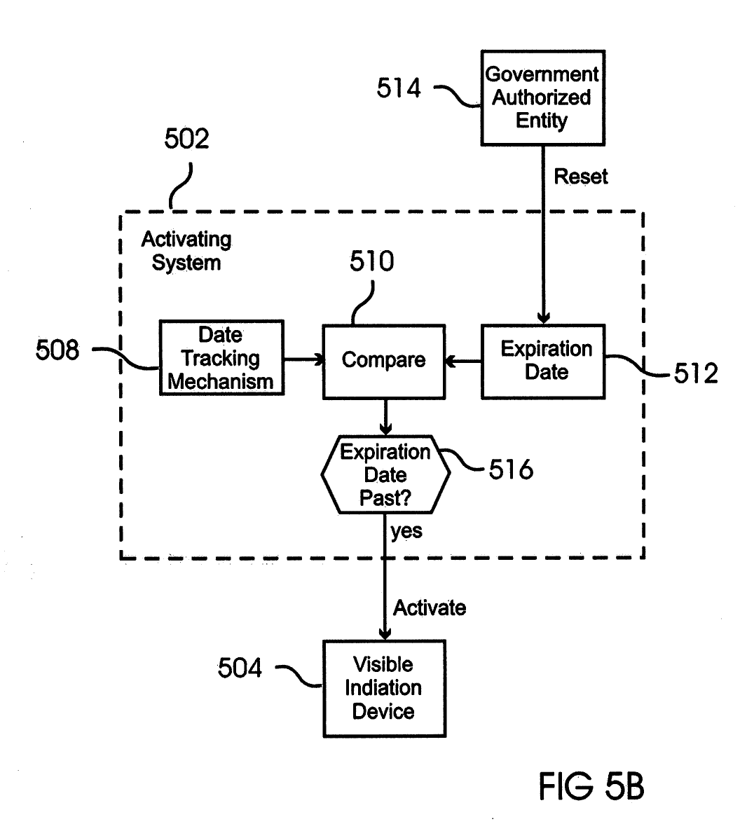

FIG. 5A is a functional diagram that illustrates a preferred embodiment wherein the apparatus is activated by a signal transmitted by a government authority 500. The government authority may wish to locate the vehicle, for example, due to a felony warrant, amber alert, serious crime, or for other, similar reasons. The wireless signal is received by the activating system 502, which immediately activates the visible indication device 504. In this preferred embodiment, the apparatus also includes a GPS unit 506. Once the visible indication device 504 has been activated, the activating system 502 obtains current location information from the GPS unit 506 and, if possible, transmits it back to the government authority 500, together with a message verifying that the visible indication device 504 has been activated. In similar preferred embodiments, other locating means are employed, such as triangulation of a signal broadcast by the activating system 502. In all cases, reception of a signal by the activating system 502 is only required for a single brief moment to activate the system, after which the visible indication device 504 enables the vehicle to be recognized and located even if mountains, tunnels, etc. prevent further wireless communication.

FIG. 5B is a functional diagram that illustrates a preferred embodiment wherein the activating system 502 activates the visible indication device 504 automatically when a vehicle fails to meet a regulatory requirement that must be met at defined intervals. In this embodiment, the activating system 502 includes a date tracking mechanism 508 that is able to determine the current date. The activating system 502 compares 510 the current date with a stored expiration date 512 that is reset by a government entity 514 each time the regulatory requirement is met. If it is found that the expiration date has passed 516, the visible indication device 504 is automatically activated.

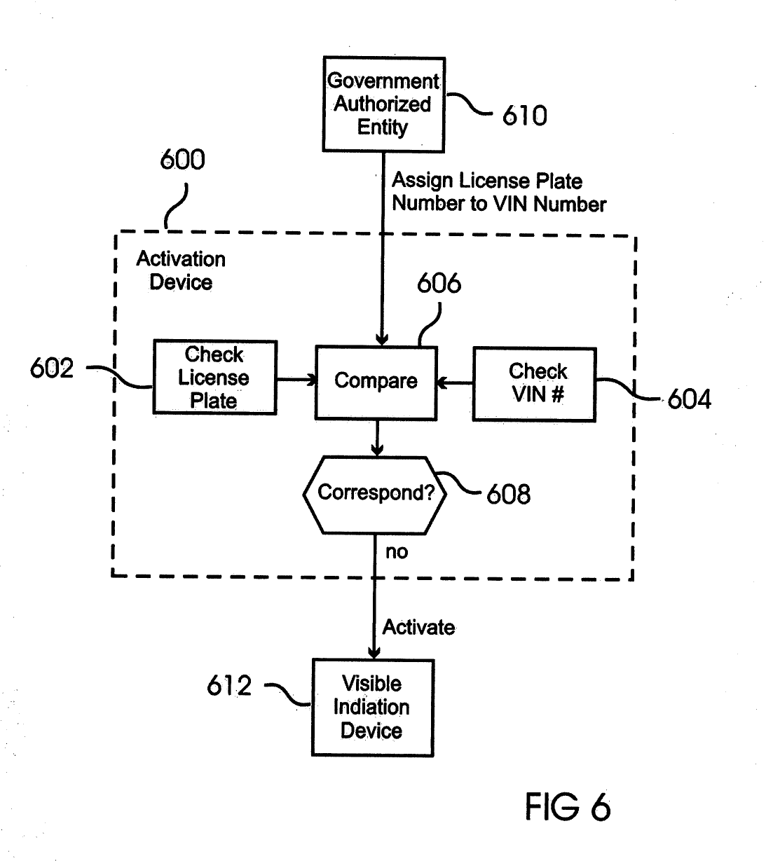

FIG. 6 is a functional diagram that illustrates a preferred embodiment wherein the activating system 600 is able to detect the license plate number 602 and the VIN number 604 and compare them 606 so as to determine if they correspond 608 with each other. Information regarding which license plate number corresponds to the VIN number is provided by a government authorized entity 610 such as the state registry of motor vehicles or department of motor vehicles. If the license plate number and the VIN number do not correspond to one another, the visible indication device 612 is automatically activated.

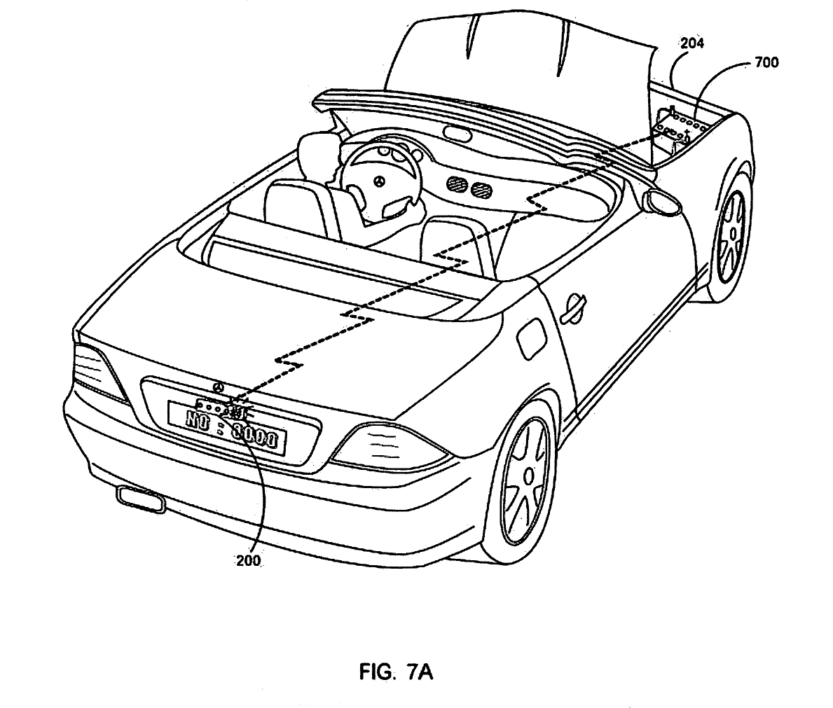

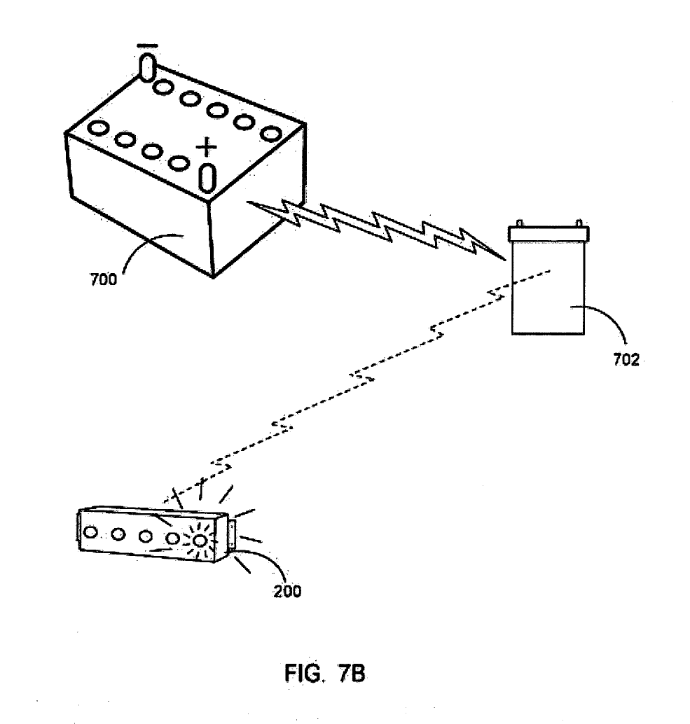

FIG. 7A is a perspective drawing that illustrates a preferred embodiment wherein the visible indication device 200 is directly powered by the vehicle battery 700.

FIG. 7B is an illustrative drawing that describes a preferred embodiment wherein the visible indication device 200 is powered by a rechargeable battery 702, which is maintained at charge by the vehicle battery 700. In the preferred embodiment of FIG. 7B, disconnecting the vehicle battery 700 from the rechargeable battery 702, or any other detected failure of the vehicle battery 700 to maintain the charge of the rechargeable battery 702, constitutes an activation condition that causes the visible indication device 200 to be activated.

Other modifications and implementations will occur to those skilled in the art without departing from the spirit and the scope of the invention as claimed. Accordingly, the above description is not intended to limit the invention except as indicated in the following claims.

What is claimed is:

1. An apparatus for providing a visible indication on a non-official motor vehicle so as to facilitate location of the motor vehicle by a government authority, the apparatus comprising:
a visible indication device attached to the motor vehicle that, when activated, is visible and recognizable from outside of the motor vehicle; and
an activating system that activates the visible indication device when an activation condition occurs.

2. The apparatus of claim 1, wherein the activating system automatically activates the visible indication device when the motor vehicle does not comply with at least one regulatory requirement.

3. The apparatus of claim 2, wherein at least one of the regulatory requirements is a requirement that must be met at defined intervals.

4. The apparatus of claim 3, wherein at least one of the regulatory requirements is at least one of vehicle registration, vehicle safety inspection, and vehicle insurance.

5. The apparatus of claim 3, wherein the activating system comprises a date tracking mechanism that is able to determine when the defined interval for meeting a regulatory requirement has passed, and wherein the activating system comprises means for updating the most recent date of compliance with the regulatory requirement.

6. The apparatus of claim 5, wherein the means for updating the most recent date of compliance with at least one regulatory requirement includes a means for allowing only a government authority to perform the update.

7. The apparatus of claim 2, wherein at least one of the regulatory requirements is a requirement that the vehicle display a license plate that is registered to the vehicle.

8. The apparatus of claim 7, wherein the activating system comprises means to automatically detect both the VIN number of the vehicle and the license number of the license plate displayed by the vehicle, and wherein the apparatus further comprises means to verify that the license plate displayed by the vehicle is registered to the vehicle.

9. The apparatus of claim 2, wherein the activating system comprises means to determine the approximate location of the motor vehicle.

10. The apparatus of claim 9, wherein one of the regulatory requirements is at least one of:
a requirement that the vehicle not leave a specified area; and
a requirement that the vehicle not come within a specified distance of a specified location.

11. The apparatus of claim 2, wherein the activating system comprises means to determine the time of day.

12. The apparatus of claim 11, wherein one of the regulatory requirements is that the vehicle not be operated at certain times during the day.

13. The apparatus of claim 1, wherein the activating system is able to detect a signal transmitted by at least one of a government authority and an automated device under the control of a government authority, and wherein the activating system activates the visible indication apparatus upon receipt of a predetermined signal from at least one of a government authority and an automated device under the control of a government authority.

14. The apparatus of claim 13, wherein the predetermined signal is transmitted when at least one of the following events occurs:
the government authority has reason to believe that the vehicle has been stolen;
the government authority has reason to believe that the vehicle has failed to meet at least one regulatory requirement;
the vehicle passes through a tollbooth without paying the required toll;
the vehicle is determined to be traveling at a speed that exceeds the legal speed limit;
the vehicle is suspected to be transporting a missing child;
the vehicle is suspected to be transporting a parole violator; and
the vehicle is suspected to be transporting an individual named in an open warrant issued by a government authority.

15. The apparatus of claim 1, wherein the visible indication apparatus attached to the motor vehicle is attached to the license plate frame of the motor vehicle.

16. The apparatus of claim 1, wherein the visible indication apparatus attached to the motor vehicle comprises a light emitting device.

17. The apparatus of claim 1, wherein the visible indication apparatus is powered by the motor vehicle battery.

18. The apparatus of claim 1, wherein the visible indication apparatus is powered by a dedicated battery.

19. The apparatus of claim 18, wherein the dedicated battery is normally maintained in a charged state by the motor vehicle battery.

20. The apparatus of claim 19, wherein the activating system automatically activates the visible indication device if the motor vehicle battery ceases to maintain the dedicated battery in a charged state.

21. The apparatus of claim 1, further comprising a device for sending a wireless signal to a government authority.

22. The apparatus of claim 21, wherein the wireless signal sent to the government authority informs the government authority that the visible indication device has been activated.

23. The apparatus of claim 21, wherein the wireless signal sent to the government authority enables the government authority to determine the approximate location of the motor vehicle.

24. The apparatus of claim 21, wherein the wireless signal is sent to the government authority using one of cellular telephone technology, radio technology, and satellite technology.

25. The apparatus of claim 1, further comprising a global positioning device (GPS) that is able to determine the location of the vehicle.

26. The apparatus of claim 1, wherein the visible indication device, when activated, displays one or more visibly distinguishable indications that provide information regarding the reason for activation of the device.

27. The apparatus of claim 26, wherein the visible indication device, when activated, displays one or more visibly distinguishable colors that provide information regarding the reason for activation of the device.

28. The apparatus of claim 1, where at least one of the activating system and the visible indication device are resistant to unauthorized tampering.

29. A method for locating a motor vehicle that has failed to comply with at least one regulatory requirement, the method comprising:
installing an apparatus on the motor vehicle including a visible indication device attached to the motor vehicle that, when activated, is visible and recognizable from outside of the motor vehicle, and an activating system that automatically activates the visible indication device when the motor vehicle does not comply with at least one regulatory requirement;
activating of the visible indication apparatus by the activating system upon failure of the motor vehicle to comply with at least one regulatory requirement; and
locating of the vehicle by at least one individual to whom the visible indication apparatus is visible.

30. A method for facilitating the location of a motor vehicle by a government authority, the method comprising:
installing an apparatus on the motor vehicle including a visible indication device attached to the motor vehicle that, when activated, is visible and recognizable from outside of the motor vehicle, and an activating system that activates the visible indication apparatus upon receipt of a predetermined signal from at least one of a government authority and an automated device under the control of a government authority;
transmitting of a predetermined signal by at least one of a government authority and an automated device under the control of a government authority;
activating the visible indication apparatus by the activating system; and
locating of the vehicle by at least one individual to whom the visible indication apparatus is visible.
